(19) United States
(12) Patent Application Publication
(10) Pub. No.: US 2005/0036867 A1
(43) Pub. Date: Feb. 17, 2005

(54) Wheelchair lift for automobile

(76) Inventor: Isaac Dyck, Morris (CA)

Correspondence Address: ADE & COMPANY, 1700-360 MAIN STREET, WINNIPEG, MB, R3C3Z3, CA

(21) Appl. No.: 10/627,971

(22) Filed: Jul. 28, 2003

(51) Int. Cl. B60P 1/00

(52) U.S. Cl. 414/522

(57) ABSTRACT

A wheelchair lift is attached to the frame underneath an automobile and includes a horizontal platform carried on a pair of parallel arms defining a platform support which is slidably received in a low profile hollow housing or container. The housing defines two end rails at right angles to the vehicle length on which the arms slide so that the arms can be moved to a cantilever position projecting from one side of the vehicle. The platform is mounted on each arm of the platform support by a pair of parallel levers for movement upwardly and downwardly from a lowered mounting position of the platform in which the wheelchair can enter onto the platform to a raised entry position in which the wheelchair can move from the platform onto the floor of the automobile. The levers are actuated by cylinders lying along the arms so that the whole of the platform and its support can be received into the housing for transport with the vehicle.

This invention relates to a wheelchair lift of a construction which can be attached to an automobile for lifting a wheelchair to floor height for entering the automobile at a side door.

### BACKGROUND OF THE INVENTION

The lifting of wheelchairs to the floor level of an automobile is a common problem for the mobility of wheelchair occupants.

Many devices have been designed which mount inside the vehicle and provide a platform which can be folded out of the vehicle to allow the wheelchair to move onto the platform and be lifted upwardly for entry into the vehicle. However the mounting of the system within the vehicle interferes with the availability of floor space within the vehicle both for the use of the wheelchair occupant and in situations where the vehicle is intended for other uses.

It is highly desirable therefore to provide a wheelchair lifting apparatus which can be mounted on the vehicle in such a manner that it does not interfere with the common use of the vehicle and yet provides an effective platform which can be raised and lowered for lifting of the wheelchair from a height at or adjacent ground level up to the floor level of the vehicle to allow the wheelchair to be wheeled into the vehicle onto the floor. This is particularly necessary for mini-van type vehicles which are commonly used as family vehicles where it is necessary in some cases for the vehicle to be used to transport a wheelchair occupant and in some cases for other purposes where the availability of the floor area around the doorways cannot be compromised.

In U.S. Pat. No. 3,258,139 (Ridgeway) is disclosed an arrangement for providing a platform for lifting wheelchair occupants into a public conveyance type vehicle or mass transit vehicle. This device therefore can be contained within a housing at one side of the vehicles since in many cases in such vehicles there is significant availability of room to contain the lifting system. The devices however entirely unsuitable for a private automobile such as a mini-van.

In U.S. Pat. No. 6,071,064 (Hackett) is disclosed a lifting system suitable for a min-van type vehicle but in this case it requires a significant modification of the vehicle in that the floor of the vehicle is cut away so the section of the floor can be raised and lowered for lifting the wheelchair occupant into the vehicle on the raised floor. While this arrangement is effective in operation and provides a floor area which is available for transporting other materials, it does require significant modifications to the vehicles structure which is expensive and which may compromise the structure and lead to warranty problems.

### SUMMARY OF THE INVENTION

It is one object of the invention to provide a wheelchair lift apparatus which is arranged to be carried on the automobile and to be readily deployed from its position on the automobile without the necessity for significant modifications to the automobile..

According to one aspect of the invention there is provided a wheelchair lift apparatus for attachment to an automobile comprising:
a platform on which the wheelchair is arranged to be received;
a platform support;
a frame;

the frame having thereon mounting members for attachment to an underside of the automobile arranged to support the frame on the vehicle with the frame horizontal and generally transverse to a length of the vehicle;

the platform support being movable while supported on the frame in a generally horizontal plane from a retracted transport position underneath the automobile to an extended operating position projecting outwardly to one side of the automobile;

the platform being mounted on the platform support for movement relative thereto, with the platform support in the extended operating position, upwardly and downwardly from a lowered mounting position of the platform in which the wheelchair can enter onto the platform to a raised entry position in which the wheelchair can move from the platform onto a floor of the automobile.

The invention also includes a combination of the automobile and the apparatus attached thereto. The term automobile is intended to include any vehicle which can contain passengers but is primarily directed to the type of vehicle which has a side door such as a mini-van or van where the wheelchair can readily enter onto the floor of the vehicle when the platform is elevated to floor level.

In a preferred arrangement to allow the platform and the platform support to be contained within the volume of the frame, the platform is carried on parallel levers each of which has one end pivotally attached to the platform and the other end pivotally attached to the platform support and which actuated by pulling one or more of the levers by one or more actuators carried on the platform support.

This construction preferably allows the platform support to slide into a hollow interior of or volume defined by the frame. In this regard the frame is preferably but may not be a closed container which defines generally a volume into which the platform and platform support are received for protection which stored underneath the vehicle.

Preferably the platform support and the frame are generally rectangular in plan with front and rear edges parallel and at right angles to the length of the automobile so that the platform support is a close fit within the frame volume.

Preferably also the platform has front and rear edges arranged at the front and rear edges of the platform support so that when moved to a common plane with the support it fits onto the support within the bounds of the support.

Preferably the frame comprises a closed hollow container with top and bottom walls within which the platform and platform support can be received.

Preferably the frame defines a depth on the automobile such that it is retained on the vehicle underneath the vehicle during travel and wherein the platform and platform support are contained within the depth of the frame.

Preferably movement of the platform relative to the platform support is effected by one or more actuators, preferably cylinders actuated by suitable fluid which are received so as to extend along the platform support parallel to the direction of sliding movement of the platform support and parallel to the plane of the platform.

Preferably the platform is carried on parallel levers each of which has one end pivotally attached to the platform and the other end pivotally attached to the platform support and which actuated by pulling one or more of the levers by one or more actuators carried on the platform support and wherein each actuator pulls a chain portion which passes over an arc member at a base of a respective one of the levers.

Preferably the frame includes a pair of parallel spaced rails extending at right angles to the length of the automobile and wherein the platform support comprising a pair of parallel arms each arranged along a respective one of the rails and slidable therealong. Where the platform is carried on two pairs of parallel levers, each pair can preferably be arranged on a respective one of the arms with the actuators each arranged to extend along a respective one of the arms and operable to pull on a respective one of the levers.

In one preferred arrangement the platform can be lowered to a height below that of the platform support and raised to a height above the platform support so that the platform reaches a height closely adjacent the ground in the lowered position. However, in cases where the wheelchair occupant is more active and the wheelchair can navigate a step the platform may have its lowered position level with the frame and the platform support.

Preferably the platform and platform support are carried wholly by the frame so as to be cantilevered in use from the side of the automobile.

### BRIEF DESCRIPTION OF THE DRAWINGS

One embodiment of the invention will now be described in conjunction with the accompanying drawings in which:

FIG. 1 is an isometric view showing a wheelchair lift in an operating raised position extending outwardly to one side of a vehicle to which it is attached.

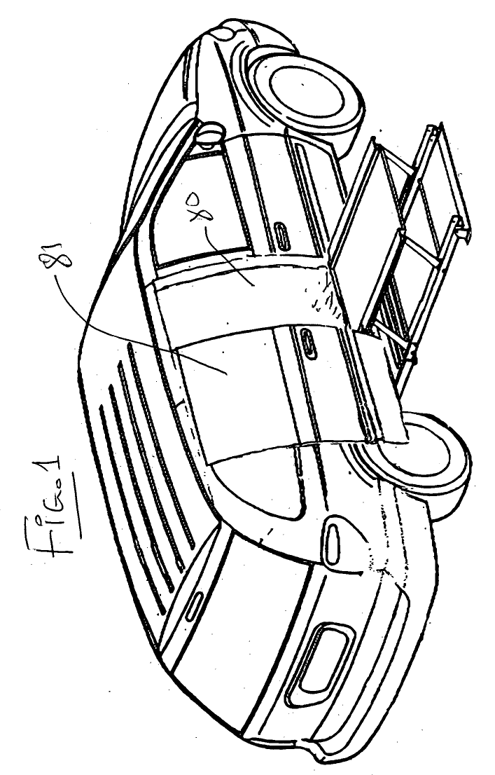

FIG. 2 is a transverse cross sectional view of the vehicle and apparatus of FIG. 1.

FIG. 3 is an isometric view showing the wheelchair lift of FIG. 1 separated from the vehicle.

FIG. 4 is an isometric view showing one arm of the wheelchair lift of FIG. 1.

FIG. 5 is a side elevational view showing one arm of the wheelchair lift of FIG. 1.

In the drawings like characters of reference indicate corresponding parts in the different figures.

### DETAILED DESCRIPTION

The apparatus as shown in the figures comprises a frame section 10, a platform support 11 and a platform 12. The frame section 10 comprises two side rails 13 and 14 which are parallel and arranged to extend across the vehicle transverse to the length of the vehicle. The side rails 13 and 14 are covered on top by a top plate 15 and on the bottom by a bottom plate 16. This defines a closed housing or enclosure which has a width equal to the spacing between the rails and a height equal to the height of the rails. The frame section is reinforced by two stiffener bars 17 and 18 extending transversely of the housing at the top plate 15 and the bottom plate 16. The stiffener bars are formed by V-shaped angle irons welded onto the plates with the apex of the angle iron projecting upwardly. One end of the housing is defined by an open mouth 19 which is stiffened by a top stiffener channel 20 and a bottom stiffener channel 21 for the housing is held ridged with a rectangular open mouth 19.

Onto the top plate 15 is welded a pair of support brackets 22 and 23 which are arranged for attachment to the underside of the vehicle.

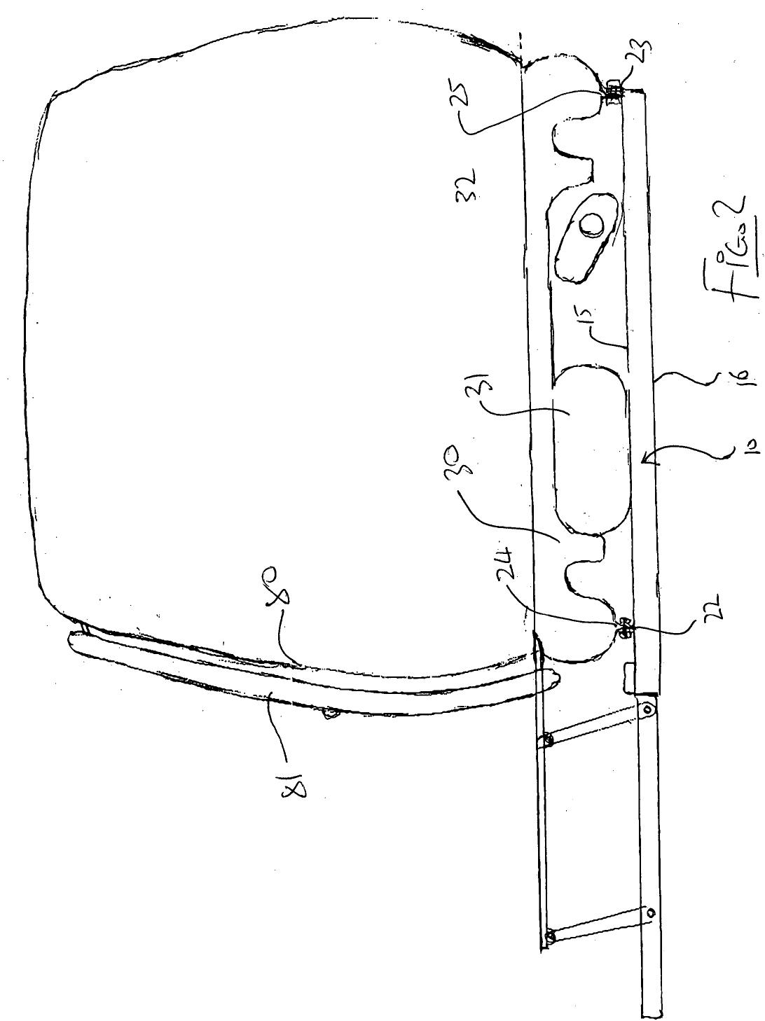

In the embodiment shown the support brackets 22 and 23 form longitudinal rails or bars which are bolted to the frame of the vehicle as best shown in FIG. 2. Thus the underside of the frame comprises a pair of flanges 24 and 25 which extend downwardly and are drilled for attachment to the bracket 22 and 23 by bolt holes 26.

It will be appreciated that the mounting arrangement as shown is suitable for a particular design of vehicle which is a Dodge mini-van. Other vehicles will have different mounting arrangements requiring different shaped brackets 22 and 23. The design of these brackets will be well apparent to one skilled in the art. The brackets need merely be attached to the top of the housing to hold the housing in position underneath the vehicle. It will be noted that in the embodiment shown the housing is located at the bottom of the frame 30 of the vehicle which provides room for the gas tank 31 and the muffler 32 which are located under the frame of the vehicle and on top of the top plate of the housing 10.

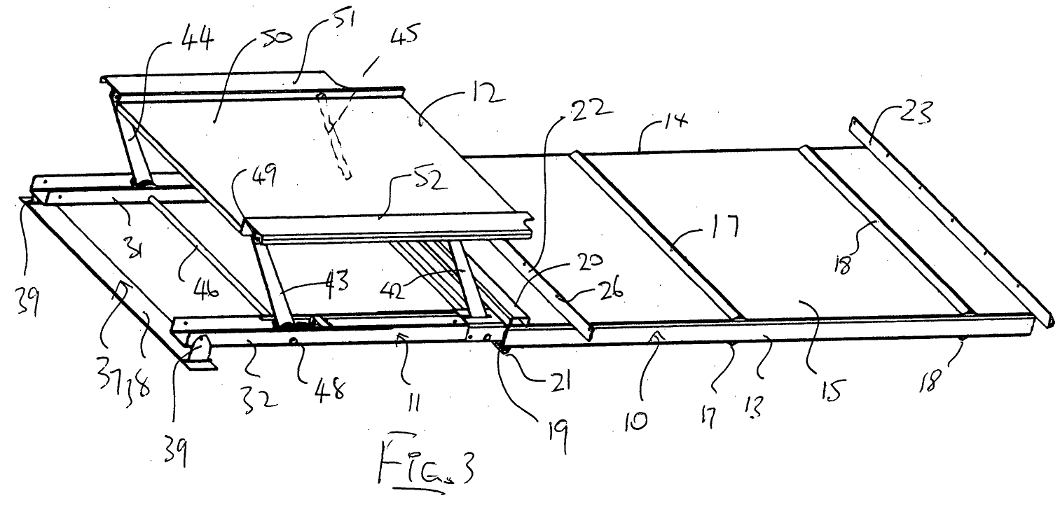

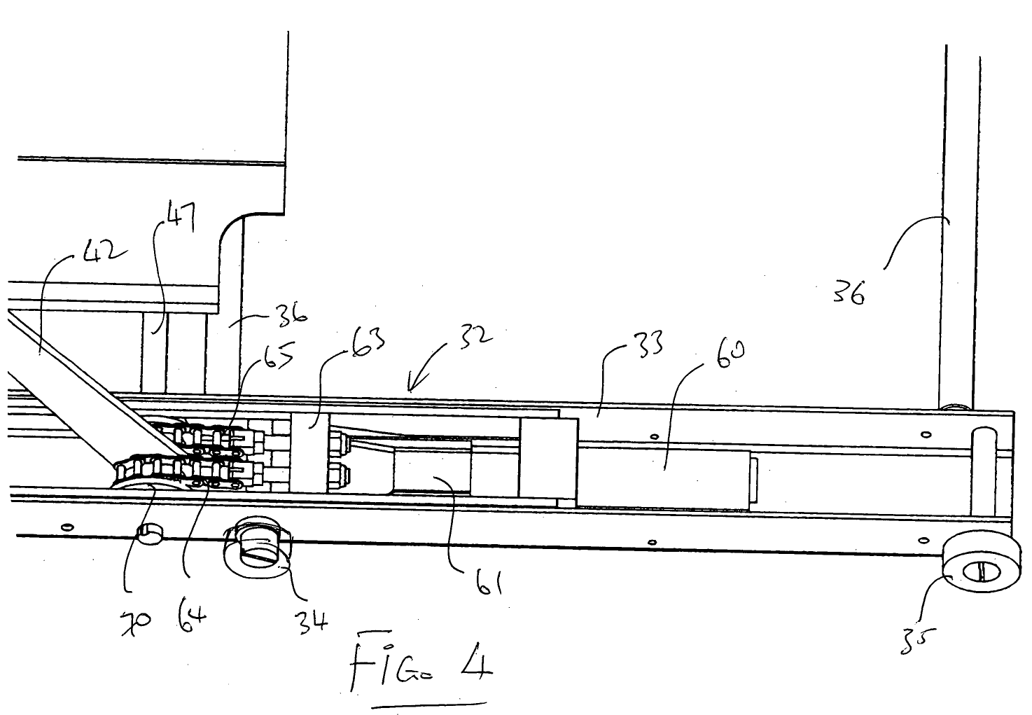

The platform support 11 comprises a pair of arms 31 and 32 which are parallel are mounted for sliding movement along the rails 13 and 14. A portion 33, shown best in FIG. 4, of each of the arms projects into the hollow interior of the housing 10 along the respective rail parallel to the rail and just inside the rail. Each of the arms carries a pair of rollers 34 and 35 which run along the inside surface of the respective rail which defines a channel or similar arrangement for receiving the roller 34, 35 thus allowing the platform support to slide from a retracted position substantially wholly within the frame to an extended position projecting outwardly from the side of the vehicle. The arms 32 and 33 are connected by a plurality of cross rails 36 which hold the arms stiff and parallel in a common plane with the housing 10. A transverse end support 37 extends across between the arm 31 and 32. The end member 37 includes a plate portion 38 and a pair of end brackets 39 which connect the plate 38 to the end of the arms in a manner which allows the plate to pivot from a horizontal position as shown in FIG. 3 to a vertical position closing the end face 19 of the housing when the platform support is inserted wholly within the housing. A suitable locking mechanism can be provided to close the end of the housing and hold the platform support within the housing thus fully enclosing the platform, platform support within the hosing 10 so that it is kept protected from contamination by dirt and other materials from the road and protected from damage.

On the arms of the platform support 11 is mounted the platform 12 which is carried on two pairs of levers. This includes a pair of levers 42 and 43 mounted on the arm 32 and a pair of levers 44 and 45 carried on the arm 31. The levers 43 and 44 are connected by a transverse rod 46 which holds the levers commonly connected in the same angular orientation and similarly the levers 42 and 45 are connected by a rod 47. Each of the levers is connected to the respective arm at its lower end at a pivot 48 and at its upper end to the platform 12 at a pivot 49. Thus the platform can move upwardly and downwardly while maintained in a horizontal plane parallel to the platform support by the four levers acting as a parallel linkage.

The levers can thus move from a lowered position in which they lie within the channel section forming each of the arms thus holding the platform at a lowered position within the plane of the platform support. The platform is defined by a horizontal platform surface 50 and at two raised side sections 51 and 52 each of which lies over the top and closes the respective channel member forming the arm 31 and 32.

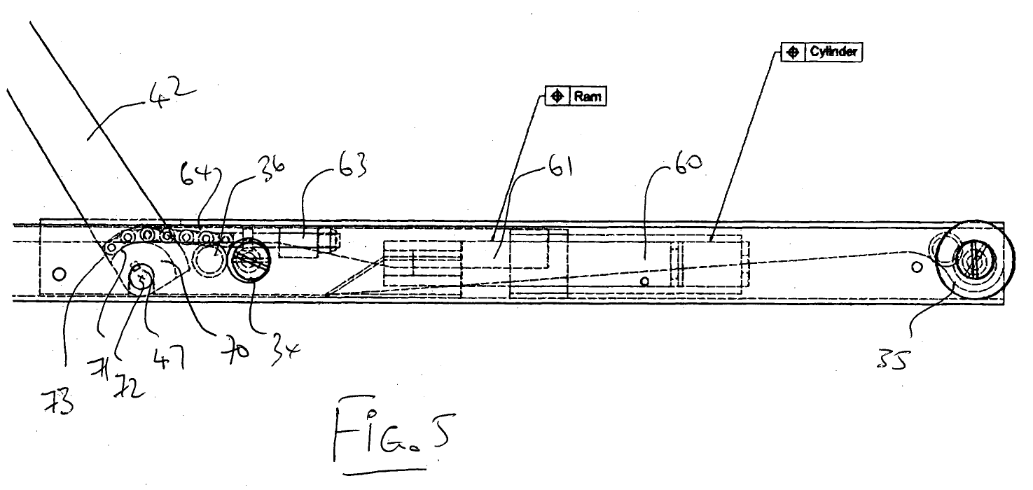

From FIGS. 4 and 5 it will be noted that within the channel member forming the respective arm is provided a cylinder 60 which forms an actuator for moving the platform upwardly and downwardly relative to the arms of the platform support. The cylinder 60 has a ram 61 which is attached to a block 63 slideable within the channel forming the arm 31 or 32. The block 63 is attached to a pair of chain portions 64 and 65. Pulling on the block 63 by the ram 61 causes the chain portion 64 and 65 to be pulled over an arc member 70 attached at the bottom of the lever 42. The arc member provides an arcuate surface 71 spaced outwardly from the pivot axis 72 of the rod 47 so that force pulling on the chain which has an outer end 73 attached at the rear end of the arcuate surface 71 causes the lever to be pivoted in a clockwise direction around the axis 72 thus causing the platform to be raised. Thus the lever can move from its lowered position lying within the channel member forming the arm to the raised position shown in FIGS. 4 and 5. The actuator thus effecting movement of the lever is thus contained wholly within the channel member forming the arm so that it can be received within the frame when the platform support is in its retracted position within the frame.

Other forms of actuator can be used which push or pull the levers into the raised positions. Thus for example linear actuators operated by electric current from the battery of the vehicle could also be used. However in all cases the actuators are received lying along the respective arm so as to be located within the frame when retracted.

It will be appreciated that in a situation where the edge portions 51 and 52 of the platform are removed, it is possible for the levers to move downwardly beyond the arms to a lowered position of the platform which is below the arms.

The mounting of the frame underneath the vehicle allows it to remain in place during normal operation of the vehicle. The frame and the platform when fully retracted within the frame does not interfere with the normal operation of the vehicle including loading the vehicle through the doorway 80 past the open door 81. The shallow height of the frame and its contents including the platform support and the platform allows the device to remain in place on the vehicle during normal operation of the vehicle without interfering with the ground clearance of the vehicle.

The platform support and the platform are wholly counter levered from the frame so that in operation there is no necessity for engagement with the ground which may be uneven. Thus the location of the platform is wholly defined by the position of the vehicle.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A wheelchair lift apparatus for attachment to an automobile comprising:
a platform on which the wheelchair is arranged to be received;
a platform support;
a frame;
the frame having thereon mounting members for attachment to an underside of the automobile arranged to support the frame on the vehicle with the frame horizontal and generally transverse to a length of the vehicle;
the platform support being movable while supported on the frame in a generally horizontal plane from a retracted transport position underneath the automobile to an extended operating position projecting outwardly to one side of the automobile;
the platform being mounted on the platform support for movement relative thereto, with the platform support in the extended operating position, upwardly and downwardly from a lowered mounting position of the platform in which the wheelchair can enter onto the platform to a raised entry position in which the wheelchair can move from the platform onto a floor of the automobile.

2. The apparatus according to claim 1 wherein the platform is carried on parallel levers each of which has one end pivotally attached to the platform and the other end pivotally attached to the platform support and which actuated by pulling one or more of the levers by one or more actuators carried on the platform support.

3. The apparatus according to claim 1 wherein the platform support is arranged such that it can slide into a hollow interior of the frame.

4. The apparatus according to claim 1 wherein the platform support and the frame are generally rectangular in plan with front and rear edges parallel and at right angles to the length of the automobile.

5. The apparatus according to claim 4 wherein the platform has front and rear edges arranged at the front and rear edges of the platform support.

6. The apparatus according to claim 1 wherein the frame comprises a hollow container within which the platform and platform support can be received.

7. The apparatus according to claim 1 wherein the frame defines a depth on the automobile such that it is retained on the vehicle underneath the vehicle during travel and wherein the platform and platform support are contained within the depth of the frame.

8. The apparatus according to claim 1 wherein movement of the platform relative to the platform support is effected by one or more actuators which are received so as to extend along the platform support parallel to the direction of sliding movement of the platform support.

9. The apparatus according to claim 1 wherein movement of the platform relative to the platform support is effected by one or more elongate actuators which are received so as to extend along the platform support in a plane generally parallel to the plane of the platform.

10. The apparatus according to claim 9 wherein the actuators comprise cylinders.

11. The apparatus according to claim 9 wherein the platform is carried on parallel levers each of which has one end pivotally attached to the platform and the other end pivotally attached to the platform support and which actuated by pulling one or more of the levers by one or more actuators carried on the platform support and wherein each actuator pulls a chain portion which passes over an arc member at a base of a respective one of the levers.

12. The apparatus according to claim 1 wherein the frame includes a pair of parallel spaced rails extending at right angles to the length of the automobile and wherein the platform support comprising a pair of parallel arms each arranged along a respective one of the rails and slidable therealong.

13. The apparatus according to claim 12 wherein the platform is carried on two pairs of parallel levers with each pair arranged on a respective one of the arms.

14. The apparatus according to claim 13 wherein the platform is raised and lowered by a pair of actuators each arranged to extend along a respective one of the arms and operable to pull on a respective one of the levers.

15. The apparatus according to claim 14 wherein the actuators comprise cylinders.

16. The apparatus according to claim 14 wherein each actuator pulls a chain portion which passes over an arc member at a base of a respective one of the levers.

17. The apparatus according to claim 1 wherein the platform can be lowered to a height below that of the platform support and raised to a height above the platform support.

18. The apparatus according to claim 1 wherein the platform and platform support are carried wholly by the frame so as to be cantilevered in use from the side of the automobile.
